(19) United States
(12) Patent Application Publication
(10) Pub. No.: US 2011/0320368 A1
(43) Pub. Date: Dec. 29, 2011

(54) DETERMINING ENVIRONMENTAL IMPACT

(76) Inventors: Kiara Groves Corrigan, San Francisco, CA (US); Amip J. Shah, Santa Clara, CA (US)

(21) Appl. No.: 12/824,699

(22) Filed: Jun. 28, 2010

(51) Int. Cl. G06Q 10/00

(52) U.S. Cl. 705/308

(57) ABSTRACT

Disclosed embodiments relate to determining environmental impact. For example, a method for determining environmental impact may include receiving, by an electronic device, environmental information indicative of an aggregate environmental impact of an activity performed by multiple entities, receiving, by the electronic device, financial information related to an entity's association with the activity, and determining, by the electronic device, the environmental impact of the entity based on the environmental information and the financial information. The method may further include outputting, by the electronic device, the determined environmental impact.

### BACKGROUND

Organizations are increasingly expected to provide information about their environmental footprint, such as information about energy use, carbon dioxide emissions, or pollution production, to satisfy consumer expectations and government regulations. Calculating the environmental impact of an organization is in some cases a complicated task. For example, it may involve large amounts of resources devoted to collecting information about the environmental impact of each of the organization's activities.

### BRIEF DESCRIPTION OF THE DRAWINGS

In the accompanying drawings, like numerals refer to like components or blocks. The drawings provide examples of the invention. The following detailed description references the drawings, wherein:

FIG. 1 is a block diagram illustrating one embodiment of a computing system.

FIG. 2 is a flow chart illustrating one embodiment of a method for determining environmental impact.

FIG. 3 is a flow chart illustrating one embodiment of a method for determining environmental impact.

FIG. 4 is a block diagram illustrating one embodiment of a method for determining environmental impact.

### DETAILED DESCRIPTION

Organizations are increasingly interested in providing information about their environmental impact. However, measuring the environmental impact of a particular organization, such as a company, school district, city, or business unit, may involve manually tracking the organization's supply chain and collecting detailed environmental impact information related to each portion of it. In some cases, a subset of data related to an organization may be used to more easily determine an organization's environmental impact. For example, information about a country's environmental impact may be used to determine the environmental impact of smaller units such as regions, or environmental impact information related to individual regions in a country may be combined to determine the environmental impact of a country as a whole. However, these methods may still involve collecting a large amount of environmental impact information related to the organization whose environmental footprint is being evaluated. In addition, the accuracy of predictions, based on the above methods may decrease as the amount of information used increases.

In one embodiment, an entity's environmental footprint is estimated based on an aggregate environmental impact of an activity. The entity's environmental impact may be determined by comparing financial information related to the entity to the aggregate impact information. For example, financial information related to the entity's association with an activity, such as revenue related to a business unit tailored to producing a particular type of goods, may be compared to aggregate environmental impact information related to the impact of the activity as performed by multiple entities. Using an aggregate environmental impact to determine an entity's environmental footprint allows for calculating the entity's environmental footprint without tracking the individual impact caused by the entity. In some cases, the environmental impact of the particular entity is not individually measured although data related to the entity may be factored into the aggregate environmental impact information. For example, sales or output by the entity being analyzed may be used when determining an economic variable, such as gross domestic product, that is used in determining the aggregate environmental impact of an activity. In one embodiment, the environmental footprint of an entity involved in multiple types of activities may be determined by determining environmental impact of each of the individual activities and summing the environmental impact of each of them to determine the environmental impact of the entity itself.

The environmental impact information may be determined, for example, from a model reflecting environmental impact in terms of an economic variable, such as environmental impact per dollar or unit of output or inputs. In one embodiment, environmental impact information is output from an Economic Input-Output Life Cycle Analysis (“EIO-LCA”) model. Financial information related to an entity may be compared to the aggregate environmental impact information to determine the environmental impact of the entity. For example, the revenue of the entity produced from performing the activity may be compared to the environmental impact of the activity produced relative to an economic input or output, such as production, profit, cost or revenue. In some cases the economic information used to determine the economic impact information is the type of information often available in public reports made by publicly traded companies.

As an example, the environmental impact information may be related to the aggregate environmental impact of the activity of manufacturing computers performed by a sector of the economy. The financial information may be related to a particular company's revenue related to output of manufactured computers. The environmental impact of the company may then be determined based on the aggregated environmental impact information related to manufacturing computers and the company's financial data related to its computer manufacturing activity.

Determining environmental impact based on aggregate environmental impact information of an activity allows an entity to determine its environmental impact without collecting environmental data specifically related to its business practices. An entity may use the method for reporting environmental information or may use the method temporarily while in the process of collecting tailored data. Because the relevant financial information may be publicly available, third parties may be able to determine an environmental impact of an entity. By allowing third parties to determine the environmental footprint, third parties may have the ability to analyze how industries or companies may be affected by environmental regulations, such as taxes, cap and trade programs, and transportation taxes. Determining environmental impact based on comparing an entity's financial information to aggregated environmental data related to multiple entities performing an activity produces approximate results.

Estimating an environmental impact based on an entity's association with an activity provides advantages. For example, an entity may evaluate its footprint as a whole, the footprint of an activity, or the environmental footprint as distributed among multiple activities associated with the entity, such as comparing the impact of business units. The method may be used to analyze the environmental impact of an entity across its supply chain. For example, an entity may use financial data related to its suppliers to determine which of its suppliers create a larger or smaller environmental impact.

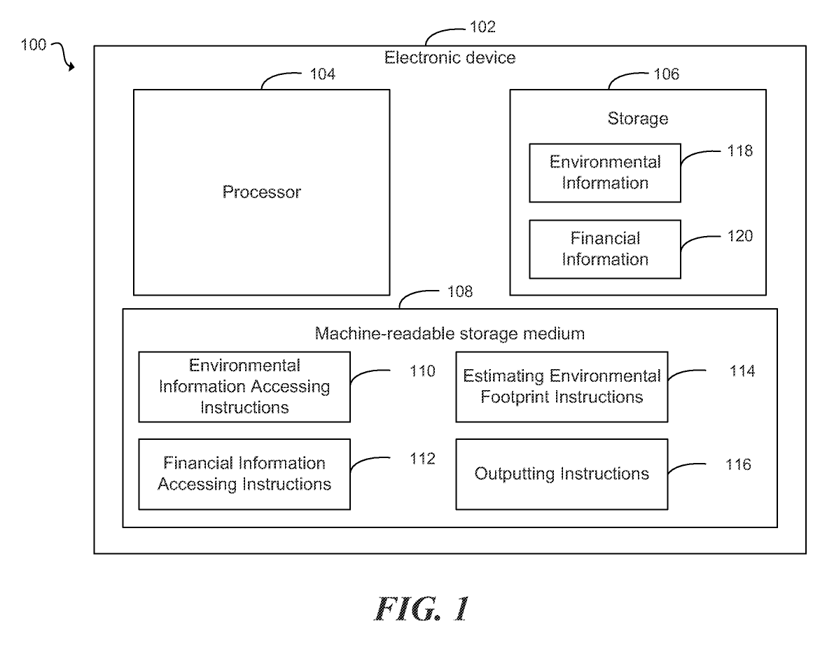

FIG. 1 is a block diagram illustrating one embodiment of a computing system 100. The computing system 100 may include an electronic device 102. The electronic device 102 may be any suitable electronic device, such as a personal computer, server, or mobile phone. The electronic device 102 may contain, for example, a processor 104, a storage 106, and a machine-readable storage medium 108.

The processor 104 may be any suitable processor, such as a central processing unit (CPU), a semiconductor-based microprocessor, or any other hardware device suitable for retrieval and execution of instructions stored in the machine-readable storage medium 108. In one embodiment, the electronic device 102 includes logic instead of or in addition to the processor 104.

The storage 106 may be any suitable storage device, such as a volatile or non-volatile memory. In one embodiment, the storage 106 is a database, such as a relational database or XML file. The storage 106 may be contained in the electronic device 102. In one embodiment, the processor 104 communicates with the storage 106 via a network such as the Internet. The storage 106 may store, for example, environmental information 118 and financial information 120.

The environmental information 118 may be any suitable environmental information. For example, the environmental information 118 may indicate water use, electricity use, carbon dioxide emissions, or pollutions. The environmental information 118 may include information about the aggregate environmental impact of an activity performed by multiple entities. For example, the environmental information 118 may include the aggregate environmental impact of an activity in a particular country or economy. In one embodiment, the environmental information 118 is related to an economic environmental model, such as an environmental impact assessment of the interdependency of an economy, industry, or sector. For example, the environmental information 118 may be calculated based on an Economic-Input Output Life Cycle Analysis Model (EIO-LCA). The environmental information 118 may describe environmental impact in any suitable terms, such as impact per unit of production, sales, purchasing price, expense, profit, or revenue.

The financial information 120 may be any suitable financial information related to an entity, such as revenue information. The financial information 120 may be related to the entity's association with an activity, such as the revenue information related to a business unit tailored to producing a particular type of goods. In one embodiment, the financial information 120 includes information typically available in a company's publicly reported financial information, such as in an annual or quarterly report of a publicly traded company. The entity may be any suitable organization that may have associated financial information, such as a company, business unit, school district, government unit, or region.

The machine-readable storage medium 108 may be any electronic, magnetic, optical, or other physical storage device that stores executable instructions or other data (e.g., a hard disk drive, random access memory, flash memory, etc.). In one embodiment, the machine-readable storage medium 108 and the storage 106 are combined into a single storage medium. The machine-readable storage medium 108 may include, for example, environmental information accessing instructions 110 for accessing the environmental information 118, financial information accessing instructions 112 for accessing the financial information 120, estimating environmental footprint instructions 114 for determining an environmental impact of an entity, and outputting instructions 116 for outputting the determined environmental impact.

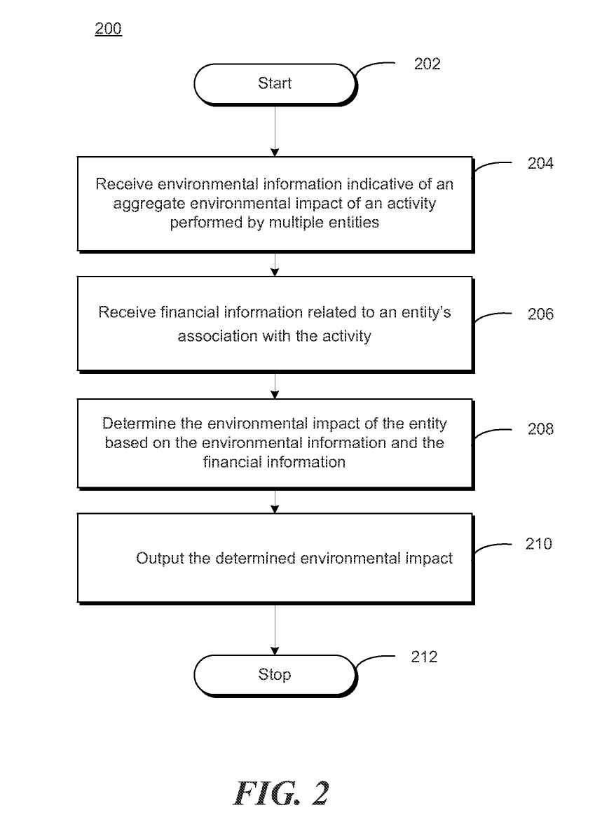

FIG. 2 is a flow chart illustrating one embodiment of a method 200 for determining environmental impact. In one embodiment, the processor 104 determines the environmental impact caused by an entity by comparing the financial information 120 to the environmental information 118. For example, the processor 104 may compare environmental information related to an aggregated environmental impact of an activity to financial data related to an entity's association with the activity. The processor 104 may then output the determined environmental impact, such as be storing it in the storage 106 or displaying it on a display device.

Beginning at block 202 and moving to block 204, the processor 104, such as by executing the environmental information accessing instructions 110, receives the environmental information 118 indicative of an aggregate environmental impact of an activity performed by multiple entities. The accessed environmental information 118 may be any suitable environmental information, such as information indicating the combined air pollution, water pollution, carbon use, or energy use caused by an activity. The aggregate environmental information 118 may be related to any suitable activity, such as the producing or selling an item, providing a service, governing an area, or supporting a business. In one embodiment, the aggregate environmental information 118 does not include environmental impact information related to the entity being evaluated. For example, the combined environmental information 118 may include data related to other entities' performance of an activity. In some cases, the environmental information 118 includes some data related to the entity even though the environmental impact of the entity is not specifically measured. For example, the environmental information 118 may be based on economic data such as gross domestic product, and the entity's production may be included in the gross domestic product.

In one embodiment, the processor 104 collects and aggregates the environmental information 118. The processor 104 may retrieve the environmental information 118 from the storage 106 or receive it from an end user or from an application. In one embodiment, the storage 106 stores aggregated environmental information related to multiple activities, and the processor 104 selects environmental information related to an activity being evaluated. The environmental information 118 may be aggregated across any suitable group of entities. For example, the environmental information 118 may be related to an environmental impact by a region, industry, or sector. In one embodiment, the environmental information 118 is related to an aggregated environmental impact in an industry in the economy, such as the computer manufacturing industry in the United States economy.

The environmental information 118 may be related to an economic variable. For example, the environmental information 118 may provide for environmental impact per dollar spent or received. In one embodiment, the environmental information 118 reflects an environmental impact per item produced or per dollar sold. The environmental information 118 may be based on an economic environmental model, such as an Economic Input Output Life Cycle (EIO-LCA) analysis model.

Moving to block 204, the processor 104, such as by executing financial information accessing instructions 112, receives financial information related to an entity's association with the activity, such as the financial information 120. The financial information 120 may be any suitable financial information, such as information about production, sales, revenue, profits, or cost. The entity may be associated with the activity in any suitable manner. For example, the entity may perform the activity or perform a related activity. The financial information 120 may be related to any suitable activity related to the entity, such as the producing a product, providing a service, or performing a support function. In one embodiment, the received information is based on the revenue of the entity or the revenue of a section or unit of the entity, such as a business unit of the entity. In one embodiment, the processor 104 receives the financial information 120 related to an entity in multiple components. For example, in a public financial report, financial information related to revenue generating business may be separated out from support services, such as selling, general, administrative, research, and development revenue and expenditures. The financial data may also be divided into subcategories related to production, such as business unit subcategories.

The financial information 120 may be received in any suitable manner. For example, the processor 104 may retrieve the financial information 120 from a storage, such as the storage 106, or the processor 104 may receive the financial information 120 from an end user or another application. In one embodiment, the processor 114 receives information indicating which information or type of information to retrieve from the storage 106. For example, the storage 106 may contain financial information related to multiple entities or related to multiple activities of the same entity, and the processor 104 may indicate which financial information should be retrieved.

Continuing to block 208, the processor 104, such as by executing the estimating environmental footprint instructions 114, determines the environmental impact of the entity based on the environmental information 118 and the financial information 120. For example, the processor 104 may compare the financial information 120 to the environmental information 118. In one embodiment, the processor 104 multiplies environmental information 118 reflecting impact per financial unit by financial information 120 reflecting the number of financial units produced or sold by the entity. For example, the environmental information 118 may indicate an environmental impact per dollar produced and the financial information 120 may indicate the number of dollars produced by the entity. In one embodiment, the processor 104 alters the method of estimating the environmental footprint based on the activity being measured.

In some implementations, the processor 104 updates the received aggregated environmental information 118 in order to determine the environmental footprint. The processor 104 may update the environmental information 118 in any suitable manner. The processor 104 may adjust the environmental information 118 to reflect the entity's association with an activity, such as the environmental practices of the specific entity. For example, the aggregated environmental information may reflect the environmental impact of an activity when performed using practices common across an industry. The entity being analyzed, however, may use procedures that are different than those accounted for in the accessed environmental information 118. For example, the entity may use more renewable energy than typical for an industry. The processor 104 may adjust the environmental information 118 to account for the entity's environmental practices. In some cases, the processor 104 may receive aggregated environmental information 118 and adjust it to account for an entity's differing practices without collecting environmental impact data related to the specific entity.

The processor 104 may use any suitable method to adjust the environmental information 118 to tailor it to the specific practices of the entity. For example, the processor 104 may receive aggregated environmental information 118 indicating that activity X produces Y metric tons of carbon dioxide per dollar of output sold. The processor 104 may receive information indicating that entity A being evaluated uses more solar power which results in less carbon dioxide being released. The processor 104 may determine that entity A uses half of its power as solar power and as a result produces Y/2 metric tons of carbon per dollar sold'.

In one embodiment, the processor 104 updates the received environmental information 118 to account for factors associated with the data used to create the environmental information 118. For example, the environmental information 118 may include aggregated environmental impact caused by entity's using a particular type of technology. The processor 104 may, for example, adjust the environmental information 118 to account for technology that was not available at the time that the environmental information 118 was collected but was available at the time that the financial information 120 was collected. The financial information 120 may be associated with an entity's finances in a particular geographic area or during a particular time period. For example, the financial information 120 may be associated with the entity's production in country X during year Y. Country X may have environmental regulations that were not taken into account in the environmental information 118. The processor 104 may adjust the environmental information 118 to account for environmental regulations in an area or time period associated with the financial information 120. In one embodiment, the processor 104 adjusts the environmental information 118 and stores the updated environmental information 118 in the storage 106 so that it may be reused for determining the environmental impact of another entity.

In one embodiment, the processor 104 updates the received financial information 120 to determine the environmental footprint. The financial information 120 may be altered in any suitable manner. For example, the processor 104 may update the financial information 120 to make its format compatible with the environmental information 118. This may allow more types of financial information to be used and increase the likelihood that publicly available financial information may be compatible with the method.

In one embodiment, the processor 104 updates the financial information 120 so that the units used for the financial information 120 correspond to the units used for the environmental information 118. For example, if the received environmental information 118 is based on revenue, the financial data 120 may be adjusted to reflect the entity's revenue. In one embodiment, the received environmental information 118 reflects an environmental impact per dollar output, and the processor 104 adjusts the financial information 120 to reflect financial information relative to units output. For example, the processor 104 may receive financial information indicating revenue and may subtract operating income in order to adjust it to dollars of production output.

In one embodiment, the processor 104 updates the financial information 120 to tailor it to a pricing level, such as the inflation rate, associated with the environmental information 118. If the environmental information 118 is based on data for a particular time period, such as a particular year, the processor 104 may adjust the financial information 120 to also reflect the pricing of that year. For example, the environmental information 118 may reflect an environmental impact per dollar in 1997 and the financial information 120 may reflect revenue in 2002. To determine a rate of inflation from a year 1997 to year 2002 producer price index, the processor 104 may divide the year 1997 producer price index by year 2002 producer price index to determine the rate of inflation. The processor 104 may then multiply the financial information 120 by the determined rate of inflation.

In one embodiment, the processor 104 adjusts the financial information 120 differently based on the type of activity it is associated with. For example, the processor 104 may update financial data related to support services in a different manner than for financial data related to business units producing a product. For support services, the processor 104 may adjust received information to reflect the cost for the support services. For a producing business unit, the processor 104 may adjust received financial information to reflect the dollars of output, such as by subtracting operating income from revenue.

After performing any updates on the financial information 120 and the environmental information 118, the processor 104 may compare the updated financial information 120 to the updated environmental information 118 to compute the environmental footprint of the entity. For example, the processor 104 may multiply the financial information 120 by the environmental information 118.

In some cases, an entity whose environmental impact is being measured may engage in multiple types of activities. For example, an entity may include multiple components, such as business units, each engaging in a different activity. Aggregate environmental data may be available for multiple types of activities, and the financial information 120 may include financial data for multiple categories, such as financial information related to manufacturing of storage devices and financial information related to manufacturing of keyboards. For each of the entity's activities, the processor 104 may multiply the financial information 120 by the environmental information 118 related to the aggregate environmental impact of the activity. If the entity engages in multiple activities, the processor 104 may then add up the environmental impact of each of the categories to determine the environmental impact of the entity as a whole.

In some cases, the activities for which the environmental information 118 is available may not match the activities for which the financial information 120 is available. For example, the processor 104 may retrieve environmental information 118 related to electric energy production and environmental information 118 related to natural gas production. The financial information 120 available from an energy company, however, may include combined output in both electric and natural gas energy. To tailor the environmental information 118 to the financial information 120, the processor 104 may use a weighted average, such as by multiplying the environmental information 118 related to natural gas by the financial information 120 and then multiplying the percentage of the business involved in natural gas. The processor 104 may also multiply the environmental information 118 related to electric energy by the financial entity 120 and then multiply by the percentage of the financial information likely to be related to natural gas. The processor 104 may then add the entity's environmental impact related to natural gas to the entity's environmental impact related to electric energy to determine the company's total impact due to energy production.

In one embodiment, the processor 104 adjusts the determined environmental impact of the entity to account for the production share of the entity, for example, based on whether some of the entity's financial data is related to production outsourced to another company. A portion of output may be produced by a third party contracting with the entity, in which case the environmental impact of the service may be applied to the third party. In some cases, the processor 104 receives information about the percentage of a good or service production that is not outsourced to a third party, and the processor may multiply the determined environmental footprint by the percentage. The processor 104 adjusts the entity environmental impact based on an average amount of outsourcing for a particular industry or product. In some cases, such as support services, the processor 104 may determine that the production share is 100% for the entity. In one embodiment, the processor 104 determines a production share for each activity performed by the entity prior to adding the environmental impact of each of the activities.

In one embodiment, the environmental impact is determined separately for different environmental variables, such as having the processor 104 calculate one environmental impact for electricity use and another environmental impact for carbon dioxide emissions. In one embodiment, the processor 104 determines an updated environmental impact if updated financial information 120 or environmental information 118 becomes available. The processor 104 receives a signal, such as from input from an end user, to indicate that the processor 104 should determine an updated environmental impact.

Continuing to block 210, the processor 104, such as by executing the outputting instructions 116, outputs the determined environmental impact. For example, the processor 104 may store the determined environmental impact, such as in the storage 106. The processor 104 may send the determined environmental impact to another electronic device or a remote storage. In one embodiment, the processor 104 displays the determined environmental impact information on a display device or formats the environmental impact information for display on another electronic device. The method 200 then continues to block 212 and ends.

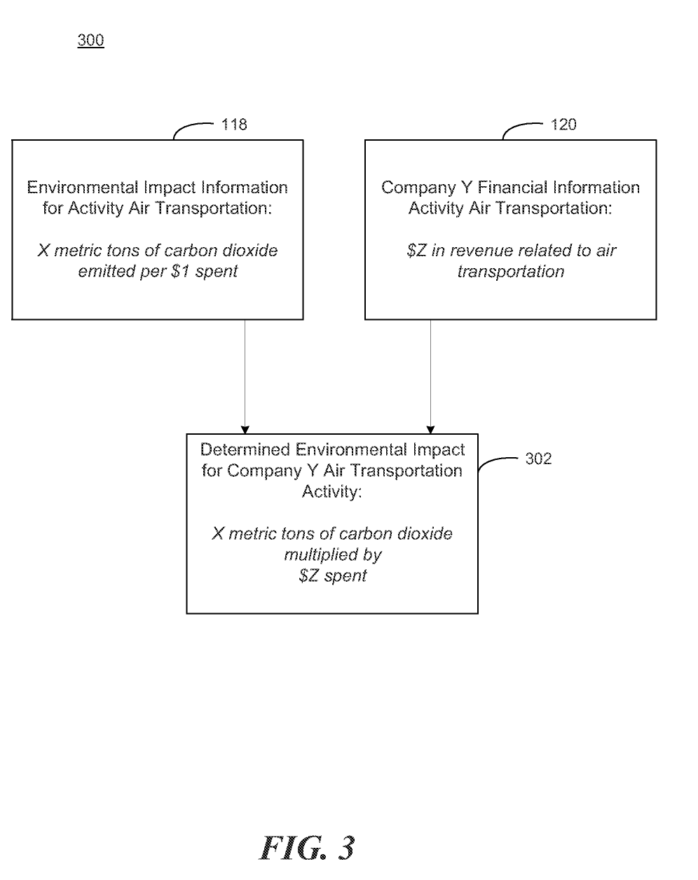

FIG. 3 is a flow chart illustrating one embodiment of a method 300 for determining environmental impact. Environmental information 118 shows aggregate environmental impact caused by activity air transportation to be X metric tons of carbon dioxide emitted for each dollar spent on air transportation. Financial information 120 shows financial information related to a specific entity, Company Y, which provides some air transportation services. Financial information 120 shows that Company Y receives $Z in revenue related to air transportation. The processor 104 may analyze the environmental information 118 and financial information 120 to determine the environmental impact 302 of Company Z's air transportation activity, such as by multiplying X metric tons of carbon dioxide emissions by $Z.

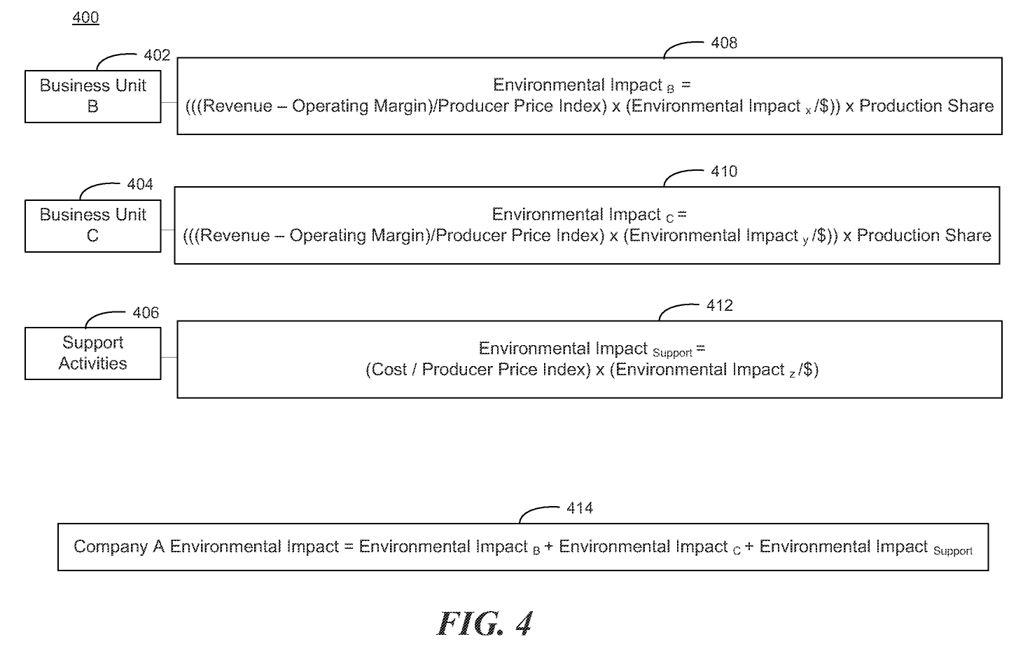

FIG. 4 is a block diagram illustrating one embodiment of a method 400 for determining the environmental impact of Company A. Company A may have financial information related to Business Unit B 402 associated with activity X and Business Unit 404 associated with activity Y. Company A may also have financial information related to Support Activities 406, such as selling, general and administrative, and research and development.

As shown in block 408, the processor 104 may determine the environmental impact of Business Unit B to be (((Revenue−Operating Margin)/Producer Price Index)×(Environmental Impact ₓ/$))×Production Share. For example, the processor 410 may receive financial information related to the revenue and operating margin of Business Unit B and environmental information related to an impact per dollar produced. To adjust the financial revenue to dollars of output, the processor 410 may subtract the operating margin from the revenue. The processor 410 may further adjust the financial information to account for the inflation rate used to determine the environmental impact information by dividing by the producer price index. The processor 410 may multiply the adjusted financial information by the environmental impact per dollar associated with the activity X performed by Business Unit B. If Business Unit B outsources some of its activities, the processor 410 may multiply the environmental impact of Business Unit B by the production share performed by the business unit itself.

As shown in block 410, the processor 104 may use a similar process for calculating the environmental impact of the Business Unit B 404 associated with activity Y. For example, the processor 410 may use Environmental Impact _{y} related the environmental impact of activity Y to determine the environmental impact of the Business Unit B. Each business unit may be treated separately, for example, because the environmental impact of the dominant activity of each business unit may have a different calculated environmental impact.

The processor 410 may use a different method for calculating the environmental impact of the Support Activities 406, for example, because the financial information related to the Support Activities 406 may be different than that related to a revenue generating business unit. In one embodiment, the processor 410 determines the environmental impact of the Support Activities 406 by calculating (Cost/Producer Price Index)×(Environmental Impact _{z}/$). The processor 410 may receive cost information related to the Support Services 406 performed by Company A. The processor 410 may adjust the cost information, for example, by dividing it by a producer price index related to inflation information for the environmental information being used. Environmental Impact _{z}/$ may indicate the aggregate environmental impact per dollar for support services. The processor may multiply the environmental impact information by the adjusted cost information to determine the environmental impact of the Support Activities 406. Other adjustments could also be made. For example, the processor 104 may update the environmental impact if some of the support services are performed by a third party.

To determine the environmental impact of Company A, the processor 410 may add the individual environmental impact of components of Company A. For example, as shown in block 414, the processor 410 may add the environmental impact of Business Unit B determined at block 408 to the environmental impact of Business Unit C determined at block 410 to the environmental impact of Support Activities determined at block 412.

According to the embodiments described above, comparing financial information to aggregated environmental data provides a simple and efficient method for determining the environmental footprint of the entity. It allows for an environmental impact to be computed without collecting detailed environmental information related to the entity being measured. In some cases, the financial information used to determine the environmental impact of an entity is the type of financial information that is often publicly available. As a result, third parties may be able to compute the environmental impact of an entity. As environmental consciousness increases, methods for determining an environmental impact of an entity will likely grow in value.

1. A computing system, comprising:
a storage configured to store:
environmental information indicative of an aggregate environmental impact of an activity performed by multiple entities; and
financial information related to an entity's association with the activity; and
a processor configured to determine the environmental impact of the entity based on the environmental information and the financial information.

2. The computing system of claim 1, wherein environmental impact information related to the entity is not included in the environmental information indicative of an aggregate environmental impact.

3. The computing system of claim 1, wherein determining the environmental impact of the entity is further based on environmental information related to the entity's association with the activity.

4. The computing system of claim 1, wherein determining the environmental impact of the entity is further based on a production share associated with the entity's association with the activity.

5. The computing system of claim 1, wherein determining the environmental impact of the entity comprises:
determining the environmental impact of components of the entity; and
determining the environmental impact of the entity based on the environmental impact of the components of the entity.

6. A method of determining environmental impact, comprising:
receiving, by an electronic device, environmental information indicative of an aggregate environmental impact of an activity performed by multiple entities;
receiving, by the electronic device, financial information related to an entity's association with the activity;
determining, by the electronic device, the environmental impact of the entity based on the environmental information and the financial information; and
outputting, by the electronic device, the determined environmental impact.

7. The method of claim 6, wherein the environmental impact of the entity is not included in the information indicative of an aggregate environmental impact of an activity.

8. The method of claim 6, wherein determining the environmental impact of the entity comprises determining the environmental impact of components of the entity.

9. The method of claim 6, wherein determining the environmental impact of the entity is further based on environmental impact information related to the entity.

10. The method of claim 6, wherein determining the environmental impact is further based on a portion of the financial information related to activities performed by the entity.

11. A machine-readable storage medium encoded with instructions executable by a processor for assessing an environmental footprint, the machine-readable medium comprising:
instructions for accessing information related to the combined environmental footprint of multiple organizations performing an activity;
instructions for accessing financial information related to an entity's association with the activity;
instructions for estimating the environmental footprint of the entity based on the environmental information and the financial information; and
instructions for outputting information indicative of the estimated environmental footprint.

12. The machine-readable storage medium of claim 11, wherein instructions for estimating the environmental footprint of the organization comprise instructions for adjusting the financial information.

13. The machine-readable storage medium of claim 11, wherein the environmental footprint of the entity is not included in the information related to the combined environmental footprint.

14. The machine-readable storage medium of claim 11, wherein estimating the environmental footprint comprises: determining a portion of the estimated environmental footprint produced by third parties associated with the entity and subtracting the portion from the estimated environmental footprint.

15. The machine-readable storage medium of claim 11, wherein estimated the environmental footprint of the organization is further based on environmental footprint information specific to the entity.
